(19) United States
(12) Patent Application Publication
(10) Pub. No.: US 2003/0213741 A1
(43) Pub. Date: Nov. 20, 2003

(54) Filter and method of manufacture

(76) Inventors: Allen B. Wright, Hope Mills, NC (US); Ledu Quoc Nguyen, Fayetteville, NC (US)

Correspondence Address: BARNES & THORNBURG, 11 SOUTH MERIDIAN, INDIANAPOLIS, IN, 46204

(21) Appl. No.: 10/147,252

(22) Filed: May 16, 2002

(51) Int. Cl. B01D 27/06

(52) U.S. Cl. 210/450; 210/493.2

(57) ABSTRACT

A fluid filter includes a filter housing and a filter module. The filter module includes a filter medium and a fusible seal. The fusible seal is bonded to a portion of the filter medium and cooperates with the housing to prevent fluid from bypassing the filter medium.

### BACKGROUND

The present disclosure relates to filters and in particular, to filters for vehicular fluids and methods of manufacturing such filters.

Fluid filters are used to filter contaminants from fluids. Filters often include a filter module that includes a filter medium through which the fluid to be filtered flows. The filter module fits in a housing. The fluid flows into the housing on one side of the filter medium, passes through the medium to the other side of the filter medium, and exits the housing. Contaminants are trapped by the filter medium.

In one common arrangement, the filter medium includes pleated filter material. The pleated material is formed into a cylinder having outer and inner side walls. The ends are then sealed. Fluid introduced into the inside of the filter then flows through the filter medium from the inner side wall to the outer side wall or vice versa. End caps for sealing the ends of the filter medium cylinder have been coupled to the ends using adhesives.

### SUMMARY

In one aspect of the present disclosure, a method of making a filter module includes providing a fusible member and a filter medium for bonding to the fusible member. The method also comprises fusing at least a portion of the fusible member, and bringing the filter medium into contact with the fused portion of the fusible member. The method further comprises permitting the fused portion of the fusible member to resolidify with the filter medium in contact with the fused portion.

In another aspect of the present disclosure, a filter module for use with a fluid filter having a housing comprises a filter medium configured to be received at least partially in the housing. The filter module also comprises a fusible seal bonded to the filter medium to cooperate with the housing to prevent fluid flow between the filter medium and the housing.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is an exploded perspective view of a fluid filter, showing a filter housing and a filter module including a filter medium formed into a pleated cylindrical filter element and a pair of seals spaced from the ends of the filter element;

FIG. 2 is a partial sectional view showing the filter assembled, the seals bonded to the ends of the filter element forming a filter module, the filter module in a filter chamber of the housing, and a filter closure securing the filter module in position in the chamber;

FIG. 3 is a fragmentary sectional view of the middle region of the seal bonded to an end of the filter element;

FIG. 4 is a perspective view of a stationary laser emitting radiation energy to fuse the middle region of the seal;

FIG. 5 is a perspective view of a laser that rotates about an axis and emits radiation energy to fuse the middle region of the seal;

FIG. 6 is a perspective view of a laser that scans back and forth along a path and emits radiation energy to fuse the middle region of the seal; and

FIG. 7 is a perspective view of a laser emitting radiation energy to fuse the middle region of the seal, and a masking apparatus positioned to block radiation energy to the inner and outer regions of the seal and permit passage of radiation energy to the middle region.

### DETAILED DESCRIPTION OF THE DRAWINGS

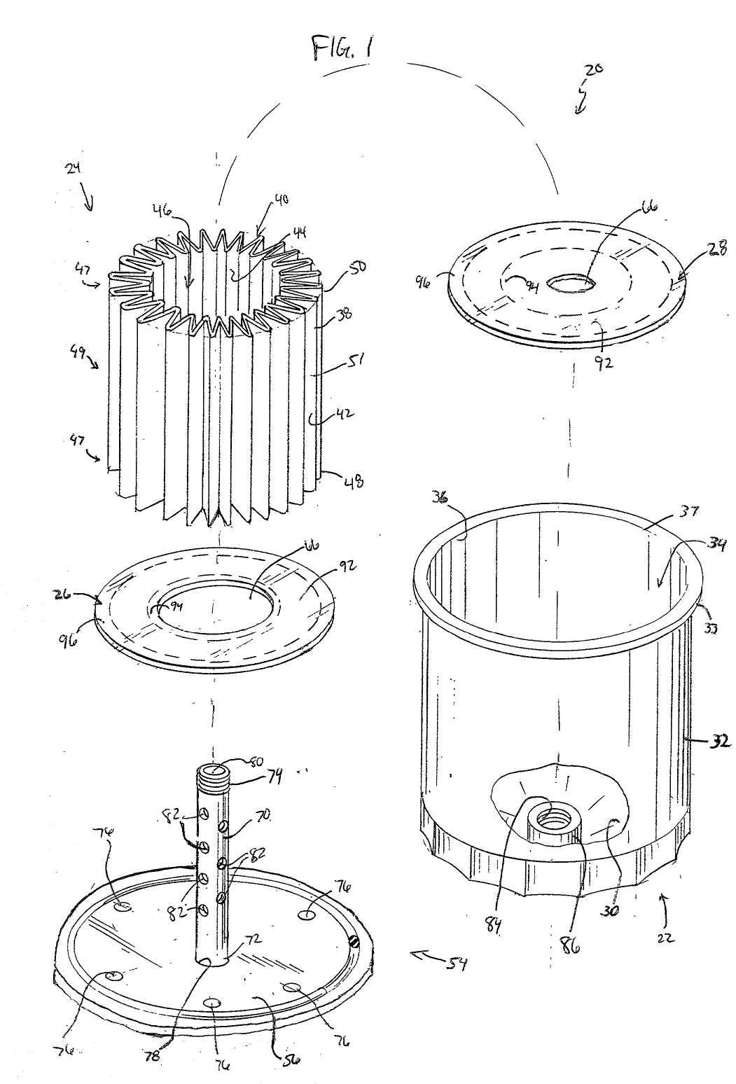

As illustrated in FIG. 1, a fluid filter 20 includes a filter housing 22 and a filter module 24 to filter fluid flowing through housing 22. Filter module 24 includes a filter medium 38 and first and second seals 26, 28 bonded to filter medium 38 to form a seal with housing 22. The bonding of seals 26, 28 prevents fluid from bypassing the filter medium 38.

Seals 26, 28 are made of a fusible material. To “fuse” is to reduce to a liquid or plastic state. Seals 26, 28 are fused and the ends 48, 50 of filter medium 38 are bonded to seals 26, 28. Illustratively, filter module 24 is constructed so that no additional components are needed to create the seal between housing 22 and filter medium 38. However, it is within the scope of this disclosure to include gaskets or the like to reduce the likelihood of leakage between seals 26, 28 and housing 22.

Seals 26, 28 are shaped to cooperate with end regions 47 of filter element 40 to prevent the fluid from bypassing filter medium 38 and passing between end regions 47 and housing 22. Illustratively, each seal 26, 28 is generally flat disk-shaped and includes a central opening 66. Seals 26, 28 are attached to filter element 40 with openings 66 aligned axially of element 40, as illustrated in FIG. 2.

As illustrated in FIG. 1, filter element 40 includes a central region 49 between end regions 47. Filter element includes an outer surface 42 facing radially outwardly from axis 41 of element 40 and an opposite inner surface 44 facing radially inwardly. Inner surface 44 defines a central region 46 into which filtered fluid flows after passing through filter medium 38. While a pleated filter element 40 is shown, it is to be understood that filter element 40 can assume any suitable shape or configuration.

As illustrated in FIG. 1, housing 22 includes an end wall 30 and a side wall 32 extending from end wall 30 and cooperating therewith to form a filter chamber 34. Side wall 32 terminates at a distal end 36 spaced from end wall 30 to border an opening 37 through which filter module 24 can be inserted and removed.

As illustrated in FIG. 2, fluid filter 20 includes a filter closure 54 providing the fluid inlet and outlet to housing 22. Closure 54 is coupled to a center tube 70 at one end 72 of the center tube 70. The other end 74 of tube 70 is threaded, as shown in FIGS. 1 and 2. Closure 54 includes one or more inlets, illustratively a plurality of inlet holes 76 formed around closure 54 at (a) distance(s) from axis 41 that places them outside of filter module 24 in the assembled filter 20. Outlet port 78 of filter 20 communicates with a passageway 80 that extends through tube 70. As illustrated in FIGS. 1 and 2, tube 70 includes a plurality of inlet openings 82 formed therein to permit filtered fluid to flow from filter 20 through outlet port 78.

As illustrated in FIGS. 1 and 2, filter module 24 is retained in chamber 34 by a filter closure 54. Filter closure 54 is illustrated in FIG. 1 as a filter bottom 56 that is coupled to filter housing 22 to form filter assembly 20. Filter closure 54 is illustrated in FIG. 2 as a filter mounting plate 58 provided, for example, on an engine block (not shown). Housing 22 and filter closure 54 are coupled together to maintain filter module 24 in chamber 34. Illustratively, filter closure 54 and distal end 36 of side wall 32 are placed adjacent each other so that center tube 70 extends through opening 66 of each seal 26, 28 and through central region 46 of filter element 40. Illustratively, threaded end 74 of center tube 70 is coupled to a threaded aperture 84 formed in boss 86 coupled to end wall 30, securing closure 54 to housing 22. However, any suitable method of coupling housing 22 and filter closure 54 is within the scope of this disclosure.

As shown in FIGS. 1 and 2, a gasket 88 is coupled to closure 54 and engages distal end 36 of side wall 32, illustratively engaging a radially outwardly projecting flange 33 provided at distal end 36. Flange 33 engages gasket 88 to seal distal end 36 to closure 54.

As illustrated in FIG. 2, a seal is formed between filter element 40 and housing 22 to prevent the fluid from bypassing filter medium 38 and flowing over end 50 of filter element 40 into port 78. Seal 28 seals against boss 86 to provide the seal between end 50 and housing 22. It is within the scope of this disclosure for seal 28 to engage end wall 30 or another structure coupled to housing 22 to provide a seal between housing 22 and filter medium 38. It is within the scope of this disclosure to provide a gasket or other means to cooperate in forming a seal between seal 28 and boss 86 or end wall 30. Seal 26 seals against filter closure 54 to prevent fluid from bypassing filter medium 38 and flowing over end 48 of filter medium 38 into port 78. It is within the scope of this disclosure to provide a gasket to cooperate in forming a seal between seal 26 and filter closure 54.

As shown by the directional arrows indicating flow of fluid in FIG. 2, fluid enters filter 20 through inlet holes 76 in closure 54 and passes through opening 37 into chamber 34. The fluid then passes through filter medium 38 into the interior 46 of filter element 40. The fluid then passes into inlet openings 82 formed in tube 70, through passageway 80, and through outlet 78 in closure 54.

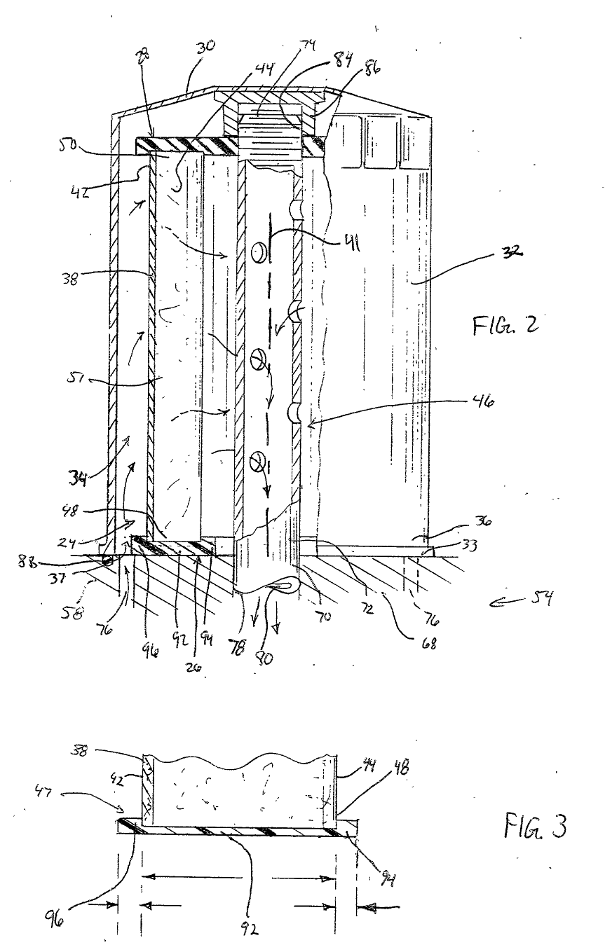

As illustrated in FIGS. 2 and 3, seals 26, 28 are coupled to ends 48, 50 of filter element 40, respectively. Seals 26, 28 are constructed from (a) fusible material(s) such as a fusible resin or polymer. An energy source, illustratively a laser 90, applies energy to a middle region 92 of each of seals 26, 28 to fuse middle region 92. Ends 48, 50 of filter element 40 are then inserted into, or otherwise applied to, the fused middle region 92. Upon solidifying or hardening of middle region 92, the seals 26, 28 are sealed and coupled to ends 48, 50.

As illustrated in FIGS. 3-7, each seal 26, 28 includes a middle region 92 bounded by an inner region 94 adjacent central opening 66 and an outer region 96 adjacent the periphery of seal 26 or 28. Laser 90 fuses only middle region 92. As illustrated in FIG. 3, middle region 92 has sufficient radial width to accommodate filter medium 38. Inner and outer regions 94, 96 remain unfused so that, when filter element 40 is inserted into the fused middle region 92, undesired radially inward or outward flow of the fused middle region 92, or flash, is minimized. Inner and outer regions 94, 96 dam the flow of the fused material displaced from middle region 92 when element 40 is applied to fused middle region 92.

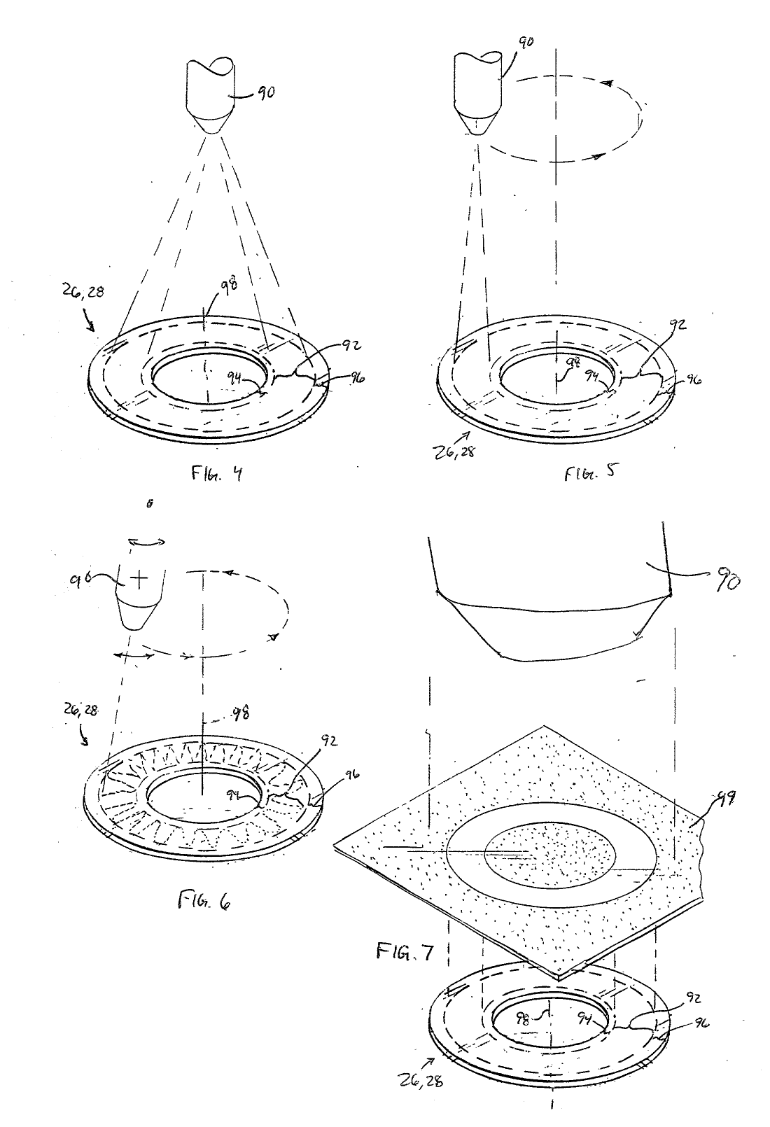

As illustrated in FIGS. 4-7, middle region 92 of each of seals 26, 28 can be fused by directing energy from the source at middle region 92 and not directing it at inner or outer regions 94, 96. FIG. 4 suggests directing energy in the form of radiation emitted from laser 90 at middle region 92 using mirrors and/or lenses (not shown) so that the energy is focused on the middle region 92. FIG. 5 illustrates relative movement between an energy source 90, such as a laser emitting energy in the form of radiation, to direct energy at or around middle region 92, and resulting in fusing the middle region 92 of each seal 26, 28. The relative movement can be achieved by rotating each seal 26, 28 about a central axis 98. Alternatively, laser 90 may be moved about axis 98 to fuse middle region 92. FIG. 6 illustrates a composite relative motion including both relative rotation and tilting to provide a scanning of the energy source 90 back and forth across the width of middle region 92. Again, this relative rotation and tilting can be achieved by moving one or the other or both of energy source 90 and seal 26 or 28, although it may most straightforwardly be achieved by rotating the seal26 or 28about its axis 98 while simultaneously tilting or “wobbling” the energy source 90. FIG. 7 illustrates using a masking apparatus 99 to mask the inner and outer regions 94, 96 from the energy source 90. As a result, only middle region 92 is fused. Any suitable energy source 90 having sufficient output power to fuse middle region 92 is within the scope of this disclosure.

A laser is currently contemplated as the energy source 90 of choice, but it is within the scope of this disclosure to use other energy sources such as infrared lamps, resistance heaters, and the like to fuse regions 92. It is also within the scope of this disclosure to construct seals 26, 28 from any material that is non-reactive with the fluid to be filtered and other environmental requirements such as thermal and/or mechanical shock resistance and that permits focused energy to selectively fuse middle region 92 without fusing inner and outer regions 94, 96. It is understood that some heat transfer between middle region 92 and inner and outer regions 94, 96 will occur, and that some amount of fusing of the inner and outer regions 94, 96 may result, and is acceptable.

Seals 26, 28 may be constructed using any suitable fusible material which permits filter medium 38 to be applied thereto. Upon hardening or solidification of middle region 92, the seal 26, 28 cooperates, bonds, captures, or becomes integral with, filter medium 38. Filter medium 38 may comprise any suitable filtration material such as, for example, cellulose, a cellular polymeric material, a metal wool, or other suitable material.

The method for manufacturing and/or assembling fluid filter 20 includes fusing a middle region 92 by applying to middle region 92 energy from the energy source 90. Once region 92 is fused, one of ends 48, 50 is of filter element 40 is applied to middle region 92. Middle region 92 then re-solidifies, bonding the seal 26, 28 to the respective end 48, 50. This process is also performed to bond the other of the seals 26, 28 to the other of ends 48, 50.

While somewhat disk-shaped seals 26, 28 are illustrated, it is within the scope of this disclosure to provide one or both of seals 26, 28 in any shape suitable for the construction of filter element 40. It is also within the scope of this disclosure to fuse the middle regions 92 of both seals 26, 28 at the same time and assemble the filter element 40 all at once, or at different times and assemble the filter element 40 sequentially. Although filter medium 38 is illustrated as a pleated structure incorporated into a cylindrical element 40, filter medium can be provided in any suitable configuration to cooperate with appropriately configured seals 26, 28 and filter housing 22 to filter fluid flowing therethrough. Additionally, it is within the scope of this disclosure to use the apparatus and method disclosed herein as or with any fluid filter, including engine and transmission oil filters, hydraulic fluid filters, air filters, fuel filters, and other filters.

Although the disclosure has been described in detail with reference to certain illustrative features or embodiments, variations and modifications exist within the scope and spirit of the disclosure as shown and described.

1. A method of making a filter module, the method comprising the steps of
providing a first fusible member,
providing a filter medium for bonding to the first fusible member,
fusing at least a portion of the first fusible member,
bringing the filter medium into contact with the fused portion of the first fusible member, and
permitting the fused portion of the first fusible member to resolidify with the filter medium in contact with the fused portion.

2. A filter module made by the method of claim 1.

3. The method of claim 1, further comprising
providing a second fusible member,
fusing at least a portion of the second fusible member,
bringing the filter medium into contact with the fused portion of the second fusible member at a location spaced apart from the first fusible member, and
permitting the fused portion of the second fusible member to resolidify with the filter medium in contact with the fused portion.

4. The method of claim 1, wherein providing a first fusible member includes providing a first fusible member comprising fusible resin or polymer that fuses upon exposure to energy of suitable intensity for sufficient time to render the resin or polymer plastic.

5. The method of claim 1, further comprising
providing a second fusible member, fusing at least a portion of the second fusible member, bringing the filter medium into contact with the fused portion of the second fusible member at a location spaced apart from the first fusible member, and permitting the fused portion of the second fusible member to resolidify with the filter medium in contact with the fused portion, the first and second fusible members being bonded to opposite ends of the filter medium.

6. The method of claim 1, wherein fusing at least a portion of the first fusible member includes fusing at least a portion of the first fusible member using a laser.

7. For use with a fluid filter having a housing, a filter module comprising
a filter medium configured to be received at least partially in the housing, the filter medium permitting flow of fluid therethrough and inhibiting contaminants from passing therethrough,
a seal bonded to the filter medium to cooperate with the housing to prevent fluid flow between the filter medium and the housing, the seal being fusible.

8. The filter module of claim 7, wherein the filter medium is porous and the seal is bonded to the filter medium by fusing at least a portion of the seal and permitting the fused at least a portion of the seal to flow into the pores.

9. The filter module of claim 7, wherein the filter medium is oriented into a cylinder.

10. The filter module of claim 9, wherein the filter medium is pleated.

11. The filter module of claim 9, wherein the seal is bonded to an end of the cylinder, and the cylinder has a bore extending longitudinally therethrough, and a fluid flows into the housing and passes from outside the cylinder, through the filter medium, into the bore.

12. The filter module of claim 7, wherein the seal comprises a material that is fusible when exposed to a sufficient intensity of energy for a sufficient period of time.

13. A fluid filter assembly for filtering a fluid comprising a housing, a filter medium having a first portion adjacent the housing and a second portion through which the fluid flows, and a first fusible seal bonded to the first portion of the filter medium to inhibit flow of fluid between the fusible seal and the first portion.

14. The assembly of claim 13, wherein the first fusible seal comprises fusible resin or polymer that fuses upon exposure to energy of suitable intensity for sufficient time to render the resin or polymer plastic to bond the fusible seal to the first portion of the filter medium.

15. The assembly of claim 13, wherein the housing includes an end wall and a side wall extending from the end wall, the filter medium is at least partially situated in the housing, and the first fusible seal is oriented between the end wall and the second portion of the filter medium.

16. The assembly of claim 13, further comprising a second fusible seal, the filter medium further includes a third portion, and the second fusible seal is bonded to the third portion.

17. The assembly of claim 16, wherein the second portion of the filter medium is between the first and third portions.

18. The assembly of claim 16, further comprising a filter closure including a fluid inlet and a fluid outlet, the filter closure cooperating with the housing and the second fusible seal to inhibit fluid flowing from the fluid inlet to the fluid outlet from bypassing the filter medium.

19. The assembly of claim 18, wherein the filter closure is coupled to the housing.

20. The assembly of claim 18, wherein the first fusible seal engages the end wall of the housing so that the filter element is between the first and second fusible seals and the end wall of the housing and the filter closure.
